(19) United States
(12) Patent Application Publication
(10) Pub. No.: US 2016/0214498 A1
(43) Pub. Date: Jul. 28, 2016

(54) CHARGING DEVICE FOR A PLUG-IN VEHICLE, AND PLUG-IN VEHICLE

(71) Applicant: Dr. Ing. h.c. F. Porsche Aktiengesellschaft, Stuttgart (DE)

(72) Inventor: Daniel Spesser, Illingen (DE)

(21) Appl. No.: 15/006,169

(22) Filed: Jan. 26, 2016

(30) Foreign Application Priority Data
Jan. 27, 2015 (DE) 10 2015 101 092.5

(51) Int. Cl. B60L 11/18; B60K 1/04

(52) U.S. Cl. CPC B60L 11/1844; B60L 11/1861; B60L 11/1848; B60K 1/04; B60L 11/1811

(57) ABSTRACT

A charging device for a plug-in vehicle includes a plurality of power components (12, 22) for transforming a polyphase supply system voltage (32) into a vehicle-end high voltage (34). Each power component (12, 22) is connected to one phase of the supply system voltage (32), and an emergency charging module switches over one of the power components (12, 22) to another phase of the supply system voltage (32). The emergency charging module switches over when the power component (12, 22) that is connected to the other phase malfunctions.

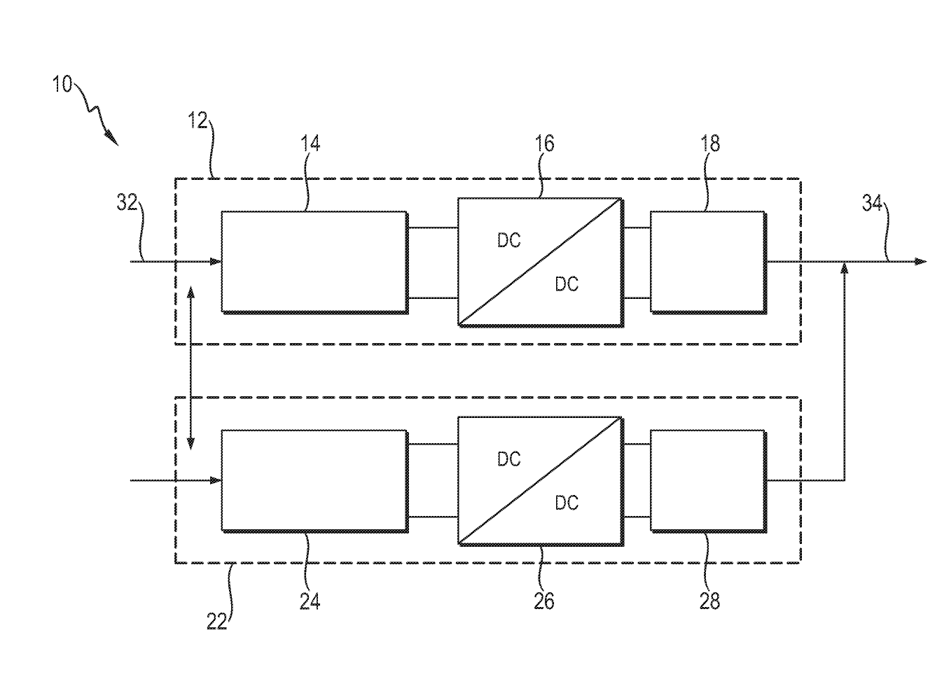

### CROSS REFERENCE TO RELATED APPLICATION

This application claims priority under 35 USC 119 to German Patent Appl. No. 10 2015 101 092.5 filed on Jan. 27, 2015, the entire disclosure of which is incorporated herein by reference.

### BACKGROUND

1. Field of the Invention

The invention relates to a charging device for a plug-in vehicle. The invention further relates to a corresponding plug-in vehicle.

2. Description of the Related Art

An interconnected arrangement of individual secondary elements or blocks which is used as an energy store for driving electric or hybrid electric vehicles and is called a drive, cycle or traction battery in automotive engineering. The prior art comprises plug-in vehicles that can be connected to a stationary power supply system by a charging cable to recharge their traction battery.

US 2014/0217814 A1 discloses a scalable high-voltage charging and detection system for plug-in vehicles of this kind. This known system comprises a high-voltage bus, a parallel relay set and a control device. The parallel relay set comprises two or more relays that are connected in parallel to one another and are electrically coupled to the high-voltage bus. The control device is programmed to adjust the current that flows through the parallel relay set when a malfunction is detected in one of the relays in the set. The system can comprise a high-voltage power source that is coupled electrically to the high-voltage bus by means of the parallel relay set. The control device reduces the current that flows through the parallel relay set by reducing an output of the high-voltage power source. The system can comprise a high-voltage motor that is coupled electrically to the high-voltage bus by the parallel relay set. The control device reduces the current that flows through the parallel relay set by reducing the power demanded by the motor.

US 2012/0123622 A1 discloses a control apparatus for a motor vehicle that has a motor designed to drive wheels. A high-voltage battery supplies electrical power to the motor, and a battery charging device charges the high-voltage battery using a power supply that is located outside the motor vehicle. The control apparatus further has a fault detection unit that is designed to detect a specific fault, and also has a driving prevention unit that is designed to prevent the motor vehicle from being driven. The driving prevention unit prevents the motor vehicle from being driven when the fault is detected by the fault detection unit during an initial check before driving of the motor vehicle is started, and when the high-voltage battery is charged using the power source that is located outside the motor vehicle immediately before the initial check.

### SUMMARY

The invention provides a charging device for a plug-in vehicle, and also a corresponding plug-in vehicle. More particularly, the charging device has individual voltage rails with a flexible configuration of independent power components. Each power component is connected to one phase of a polyphase stationary supply system voltage and transforms the supply system voltage into a vehicle-end high voltage. However, a power component can be switched over to another phase of the supply system voltage if required. This special emergency charging mode is activated automatically by a corresponding control module as soon as the power component that currently is connected to the phase in question malfunctions. A comparable emergency operation mode in which a technical part performs its specific task even under irregular conditions over a limited time to maintain operation is known to a person skilled in the art from other technical fields as the limp-home mode.

The emergency charging module of the invention ascertains the maximum available charging power per functional voltage rail after diagnosis of each individual voltage rail and, in the event of a breakdown or defect in the power component in question, provides the described emergency function, which nevertheless allows electrical charging of the traction battery by the stationary power supply system—albeit at reduced power. For example, in the event of breakdown of a voltage rail, a switchover is made automatically from three-phase current to 230 volts by a still functional power component being selected. Therefore, the objective of a greatest possible availability with an optimum energy charging balance is achieved, despite the defective hardware, at the cost of a moderate power reduction, without the plug-in vehicle having to be taken to a garage.

### BRIEF DESCRIPTION OF THE DRAWING

The single FIGURE shows a circuit diagram of a 7.2 kW charging device in a vehicle.

### DETAILED DESCRIPTION

The FIGURE illustrates the schematic design of a charging device 10 according to the invention for a plug-in vehicle. The charging device 10 comprises two power components 12, 22 for transforming a two-phase supply system voltage 32 into a vehicle-end high voltage 34. Each power component 12, 22 is connected to one of the two phases of the supply system voltage 32. Each of the power components 12, 22 comprises a central direct-current converter 16, 26, an upstream active harmonic filter 14, 24 and a downstream rectifier 18, 28 and is designed so that the charging device 10 outputs a total charging power of 7.2 kW.

In addition to the outlined power components 12, 22, the charging device 10 comprises the emergency charging module—not illustrated in the drawing—that collects diverse diagnosis information and implements the respective operating strategy. A first functional block of emergency charging module thus serves for monitoring the power components 12, 22. To this end, the first functional block evaluates operating parameters, such as coolant temperature of the plug-in vehicle, energy throughput or operating temperature of the two power components 12, 22. As soon as these characteristic values indicate malfunctioning of one of the power components 12, 22, a second functional block of the emergency charging module disables the malfunctioning power component 12, 22 and switches over the remaining power component 22, 12 to the appropriate voltage rail.

A third functional block of the emergency charging module provides diagnosis information in an extremely wide variety of ways. This diagnosis information may comprise available power of each power component 12, 22 or total available power of the charging device 10. Examples include, for example, a man/machine interface of the plug-in vehicle, a suitable app or transmission of diagnosis information, which may comprise replacement recommendation if required, to a customer service center.

What is claimed is:

1. A charging device for a plug-in vehicle, comprising:
a plurality of power components for transforming a polyphase supply system voltage into a vehicle-end high voltage, each power component being connected to a first phase of the supply system voltage, and
an emergency charging module for switching over one of the power components to a second phase of the supply system voltage, the emergency charging module being configured to switch over when the power component that is connected to the first phase malfunctions.

2. The charging device of claim 1, wherein the charging device comprises three power components, and the supply system voltage has three phases.

3. The charging device of claim 1, wherein the power components are configured so that the charging device outputs a charging power of 7.2 kW.

4. The charging device of claim 1, wherein the emergency charging module comprises at least one of:
a first functional block for monitoring the power components, and
a second functional block for disabling the malfunctioning power component.

5. The charging device of claim 4, wherein the first functional block is configured so that monitoring of the power components comprises evaluating at least one operating parameters of each power component selected from:
an energy throughput and
an operating temperature.

6. The charging device of claim 4, wherein the first functional block is configured so that monitoring of the power components comprises evaluating a coolant temperature of the plug-in vehicle.

7. The charging device of claim 4, wherein the emergency charging module further comprises a third functional block for providing diagnosis information.

8. The charging device of claim 7, wherein the third functional block is configured so that the diagnosis information comprises at least one of:
an available power of each power component and
a total available power of the charging device.

9. The charging device of claim 7, wherein the third functional block is configured so that the diagnosis information is provided in one of the following ways:
by means of a man/machine interface of the plug-in vehicle,
by means of an app or
by transmitting the diagnosis information to a customer service center.

10. A plug-in vehicle, comprising:
an electric motor for driving the plug-in vehicle,
a traction battery connected electrically to the electric motor for supplying a high voltage to the electric motor, and
the charging device of claim 1 for charging the traction battery from a polyphase supply system voltage.
